(19) United States
(12) Patent Application Publication
(10) Pub. No.: US 2012/0033616 A1
(43) Pub. Date: Feb. 9, 2012

(54) MOBILE TERMINAL AND PEER-TO-PEER MODE BASED DATA TRANSMISSION METHOD THEREOF

(75) Inventor: Guochen Sun, Qingdao (CN)

(73) Assignee: HISENSE MOBILE COMMUNICATIONS TECHNOLOGY CO., LTD., Qingdao, Shandong (CN)

(21) Appl. No.: 13/265,294

(22) PCT Filed: Apr. 19, 2010
(86) PCT No.: PCT/CN2010/071863

§ 371 Date: Oct. 19, 2011

(30) Foreign Application Priority Data
Apr. 21, 2009 (CN) 200910135522.1

(51) Int. Cl. H04W 4/00; H04L 12/56

(52) U.S. Cl. 370/328

(57) ABSTRACT

The application relates to field of the mobile communication, specially relates to an instant communication technology for realizing peer-to-peer (P2P) mode between mobile terminals. The application provides a mobile terminal and a P2P mode based data transmission method thereof. The method comprises the following steps of: generating a data packet from information input by a user, wherein the data packet carries an identification of the opposite-end communication equipment and a number of a receiving port; sending the data packet to a base station via a predefined sending port; if it is monitored that the data packet is received at the receiving port, obtaining information from the received data packet. Since the mobile terminal sends the data packet to the opposite-end equipment directly via the sending port according to the identification of the opposite-end equipment, and receives the data packet returned by the opposite-end equipment by monitoring the receiving port, the instant communication data transmission between mobile terminals can be realized without the support of the instant communication server.

This application claims priority to Chinese Patent Application No. 200910135522.1, filed with the State Intellectual Property Office of China on Apr. 21, 2009 and entitled “Mobile terminal and peer-to-peer mode based data transmission method thereof”, which is hereby incorporated by reference in its entirety.

### FIELD OF THE INVENTION

The present invention relates to the field of mobile communications and particularly to a technology of instant communication in the P2P mode between mobile terminals.

### BACKGROUND OF THE INVENTION

At present, network information systems may fall into two categories, application systems in a Client/Server (C/S) architecture and those in a Peer to Peer (P2P) architecture, respectively. The P2P application allows direct mutual communication between hosts over the Internet, and a P2P overlay network is formed among numerous peers, so that various data (e.g., text files, and video files) can be shared conveniently among the common hosts. This will be very promising with respect to global instant communication (e.g., Skype), sharing of files (e.g., BT), distributed computing, cooperative operation, etc.

Briefly, the P2P enables direct communication of people so that they can interact directly over the Internet. The P2P facilitates easier communication and more direct sharing and interaction over the network by eliminating any middleman indeed. People can connect themselves directly to computers of other users through the P2P technology for exchange of files instead of connecting themselves to a server for browsing or downloading as would be required before. Another important characteristic of the P2P is to change the status of centering on a website as common over the Internet and to return to “non-centralization”. Actually, people communicate face to face or by phone in real life also in the P2P mode.

Along with the evolvement of the General Packet Radio Service (GPRS) and the third generation communication technologies, telecommunication and computer networks have been linked organically together to develop toward a future all-Internet Protocol (IP) network platform.

As can be apparent from the GPRS architecture, typically a base station and a Serving GPRS Support Node (SGSN) are connected through a frame relay, and the SGSN and a Gateway GPRS Service Node (GGSN) are connected over an IP network. The GGSN may have a router capable of network address translation play the role of converting between an internal IP address and an external network IP address, and a mobile terminal may access a GPRS internal network and may also access an external Public Data Network (PDN)/Internet network through an Access Point Name (APN) of the external network.

To identify a GPRS device, an IP address may be allocated, for example, in the identifier of a mobile terminal, in addition to an International Mobile Subscriber Identity (IMSI) used in the Global System for Mobile Communication (GSM). The identifier of a network element device of SGSN and GGSN includes an address of Signaling System Number 7 and an IP address of the data GGSN, the IP address is used for communication between GSNs (the SGSN or the GGSN), and the address of Signaling System Number 7 is used for communication between entities of a Gigabyte System Network (GSN) and a Mobile Switching Center (MSC). In a GPRS system, there are two important databases for recording information, one of which is a user mobility management context for management of positional information of a mobile user, and the other of which is a user Packet Data Protocol (PDP) context for management of data routing information between a mobile terminal and the GGSN and between the GGSN and an Internet Service Provider (ISP). When the mobile terminal accesses the GPRS internal network or the external PDN/Internet network, the mobile terminal transmits a PDP context activation request message to the SGSN, and the mobile terminal may subscribe with an operator to select a fixed serving GGSN, or the SGSN may select a serving GGSN under an APN selection rule, and then the SGSN transmits a PDP context creation request message to the GGSN. The GGSN allocates an IP address (static or dynamic, or public or private) to the mobile terminal and may authenticate and verify the identity of and the quality of service required for a mobile terminal user while creating a PDP context, and after the PDP context is created and activated successfully, PDP context information of the user is stored at the mobile terminal, the SGSN and the GGSN. With positional information of the user and routing information of data, the mobile terminal can access a resource of the network.

At present, instant communication software for mobile terminals, e.g., Fetion and QQ, operates in the C/S mode, i.e., the Client/Server mode. In other words, the mobile terminals have to log in an instant communication server for instant communication, and forwarding of data between the mobile terminals may be supported over a platform of the instant communication server, thereby performing instant communication between the mobile terminals. If there are a too large number of concurrently online users, phenomena of slow processing by the instant communication server, a loss of data, etc., may occur, and there may be a significant delay of time due to forwarding through the instant communication server; and the phenomenon of a delay of time may be more pronounced and the speed may be very low especially with transmission of a file. Furthermore, the mobile terminal may fail to log in the network some time when the instant communication server is busy. Moreover, personal information stored on the server may be exposed to a risk of malicious or unintentional reveal and controlled by a radio operator with a consequential additional charge.

### SUMMARY OF THE INVENTION

Embodiments of the invention provide a mobile terminal and a data transmission method thereof in the P2P mode to enable transmission of instant communication data between mobile terminals without being supported by any instant communication server.

A data transmission method in a P2P mode for a mobile terminal includes:

generating, by the mobile terminal, a data packet from information input by a user, wherein the data packet carries an identifier and a reception port number of a communication device at the opposite end;

transmitting, by the mobile terminal, the data packet to the communication device at the opposite end through a base station; and

monitoring a predefined reception port, and acquiring, from a received data packet, information transmitted from the communication device at the opposite end upon detecting reception of the data packet via the reception port and determining the received data packet as being transmitted from the communication device at the opposite end.

A mobile terminal includes:

a data packet generation module configured to generate, from information input by a user, a data packet carrying an identifier and a reception port number of a communication device at the opposite end;

a data packet transmission module configured to transmit the data packet to the communication device at the opposite end through a base station;

a port monitoring module configured to monitor a predefined reception port; and

a data packet reception module configured to acquire, from a received data packet, information transmitted from the communication device at the opposite end upon determining the received data packet as being transmitted from the communication device at the opposite end when the port monitoring module detects reception of the data packet via the reception port.

The mobile terminal according to the embodiment of the invention transmits a data packet directly to the device at the opposite end according to the identifier of the device at the opposite end through the base station and receives a data packet returned from the device at the opposite end by monitoring the reception port instead of firstly transmitting information of instant communication to an instant communication server, which in turn forwards it to the device at the opposite end, thereby enabling transmission of instant communication data between the mobile terminals without being supported by any instant communication server.

### BRIEF DESCRIPTION OF THE DRAWINGS

FIG. 1 is a flow chart of a method for adding an opposite peer as a friend prior to instant communication according to an embodiment of the invention;

FIG. 2 is a flow chart of a method for performing instant communication with an opposite peer according to an embodiment of the invention;

FIG. 3 is a flow chart of another method for adding an opposite peer as a friend prior to instant communication according to an embodiment of the invention;

FIG. 4 is a flow chart of a method for exiting instant communication with an opposite peer according to an embodiment of the invention; and

FIG. 5 is an internal structural diagram of a mobile terminal for performing instant communication with an opposite peer according to an embodiment of the invention.

### DETAILED DESCRIPTION OF THE EMBODIMENTS

According to embodiments of the invention, the concept of P2P is introduced into direct instant communication of a mobile terminal with a friend over a radio network without any instant communication server and radio operator. In an instant communication tool provided for a mobile terminals in the embodiments of the invention, a port is predefined for the tool as a communication reception port of the tool; data transmitted from the mobile terminal to the opposite end of communication is transmitted to a base station via a port dynamically allocated by the system; and the mobile terminal monitors the predefined reception port, acquires a data packet upon determining reception of the data packet via the reception port and acquires information from the data packet. Since the reception port of instant communication is defined for each of the mobile terminals, the mobile terminal may transmit data directly to the reception port at the opposite end, and the mobile terminal may acquire data transmitted from the opposite end by monitoring the its own reception port, thereby performing instant communication between the mobile terminals without being supported by any instant communication server at the network side.

A technical solution according to an embodiment of the invention is described in detail hereinafter with reference to the drawings.

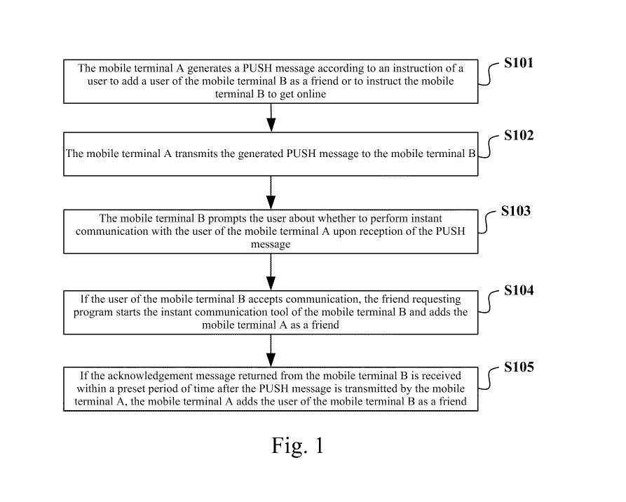

Assumed that instant communication is performed between a mobile terminal A and a mobile terminal B without being supported by any instant communication server. Then before the mobile terminal A performs instant communication with the mobile terminal B, the mobile terminal A instructs the mobile terminal B to get online or adds the mobile terminal B as a friend in a process, as illustrated in FIG. 1, including the following steps.

S101. The mobile terminal A generates a PUSH message according to an instruction of a user to add a user of the mobile terminal B as a friend or to instruct the mobile terminal B to get online.

After the user starts the instant communication tool provided according to the embodiment of the invention, the instant communication tool may perform the following operations.

The mobile terminal A generates the PUSH message (a push message, which is wirelessly transmitted typically through an SMS protocol) according to the instruction of the user to add the user of the mobile terminal B as a friend or to instruct the mobile terminal B to get online. The PUSH message carries a processing program identifier to identify a program for processing the PUSH message (i.e., instant communication requesting program), number of the local mobile terminal (i.e., the mobile terminal A) and an IP address of the local mobile terminal (i.e., the mobile terminal A). Furthermore, the PUSH message may also carry information on a nickname of the user, a timeout period of time, etc.

S102. The mobile terminal A transmits the generated PUSH message to the mobile terminal B.

The mobile terminal A transmits the PUSH message to the mobile terminal B according to number of the mobile terminal B (e.g., an IMSI).

S103. The mobile terminal B prompts the user about whether to perform instant communication with the user of the mobile terminal A upon reception of the PUSH message.

Upon reception of the PUSH message, the mobile terminal B invokes the instant communication requesting program according to the processing program identifier carried in the PUSH message to process the PUSH message. Specifically, the instant communication requesting program of the mobile terminal B parses the PUSH message, acquires the information on the number and the IP address of the mobile terminal A carried in the PUSH message, and displays a related prompt (for example, the prompt includes the number or the IP address of the mobile terminal A, or the nickname of the user of the mobile terminal A) on a display screen to prompt the user about whether to perform instant communication with the user of the mobile terminal A.

S104. If the user of the mobile terminal B accepts communication, the instant communication requesting program starts the instant communication tool of the mobile terminal B, adds the mobile terminal A as a friend (that is, gets ready to perform instant communication with the mobile terminal A to receive data from the IP address of the mobile terminal A or transmit data to the mobile terminal A) and transmits an acknowledgement message.

If the user of the mobile terminal B accepts, the mobile terminal B starts the instant communication tool of the mobile terminal B in response to an acceptance instruction of the user to add the mobile terminal A as a friend and may transmit a PUSH message to the mobile terminal A according to the number of the mobile terminal A to indicate that the mobile terminal B has gotten online, where the PUSH message includes an identifier to indicate the PUSH message as an acknowledgement message, and information on an IP address of the mobile terminal B or a nickname of the user of the mobile terminal B, etc.

Alternatively, the mobile terminal B transmits a data packet including acknowledgment information to the predefined reception port of the mobile terminal A via a transmission port dynamically allocated by the system to indicate that the mobile terminal B has gotten online. The mobile terminal A monitors the predefined reception port and may start instant communication with the mobile terminal B upon detecting reception of the data packet and determining the data packet is transmitted from the mobile terminal B and includes the acknowledgment information.

If the user of the mobile terminal B does not accept communication, the flow performs no process but ends.

S105. If the acknowledgement message returned from the mobile terminal B is received within a preset period of time after the PUSH message is transmitted by the mobile terminal A, the mobile terminal A adds the user of the mobile terminal B as a friend, that is, gets ready to perform instant communication with the mobile terminal B to receive data from the IP address of the mobile terminal B or transmit data to the mobile terminal B.

Specifically, the mobile terminal A determines, according to the identifier of the acknowledgement message in the PUSH message, that the PUSH message is an acknowledgment message, then extracts the IP address of the mobile terminal B in the PUSH message, and is ready to transmit a data packet to the IP address of the mobile terminal B or receive a data packet from the mobile terminal B.

The mobile terminal A determines a failure of instruction if no acknowledgement message returned from the mobile terminal B is received within the preset period of time after the PUSH message is transmitted by the mobile terminal A.

The mobile terminal at the opposite end may be instructed with the PUSH message (i.e., a short message) to get online for instant communication to thereby achieve an enhanced nature of real time. If a user is offline, the user may be instructed with a short message, etc., to get online for communication. This can not be achieved at present for PC terminals capable of P2P instant communication over the Internet.

Although a specific solution has been described as above by way of an example in which the user of the mobile terminal B is instructed to get online, those skilled in the art can readily implement, in light of the foregoing technical disclosure of the embodiment of the invention, such a technical solution that a short message may be broadcast to a plurality of users of mobile terminals to instruct them to get online, a repeated description of which is omitted here.

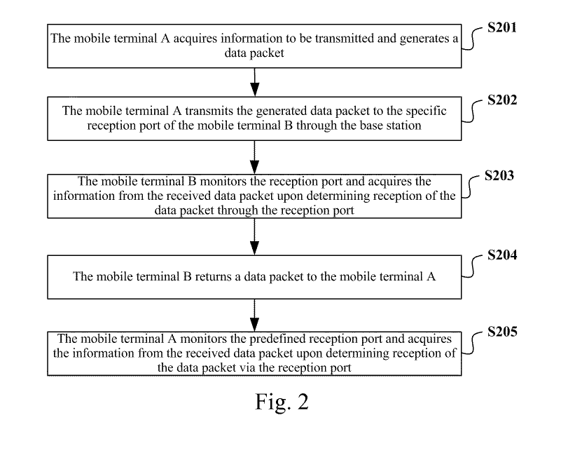

After the mobile terminal A instructs the mobile terminal B to get online, the user of the mobile terminal B starts the instant communication tool in the mobile terminal B to add the user of the mobile terminal A as a friend, and then the mobile terminal A may perform instant communication with the mobile terminal B in a method, as illustrated in FIG. 2, including the following steps.

S201. The mobile terminal A acquires information to be transmitted and generates a data packet.

For example, the mobile terminal A acquires text information input by the user or a file specified by the user and generates, from the acquired information, a data packet carrying the identifier, e.g., the IP address, of the mobile terminal B. The data packet may be a data packet in the format of the User Datagram Protocol (UDP) or a data packet in the format of the Transmission Control Protocol (TCP), the UDP data packet is preferred.

If there is much information to be transmitted, the information may be transmitted in a plurality of data packets.

S202. The mobile terminal A transmits the generated data packet to the specific reception port of the mobile terminal B through the base station.

The mobile terminal A transmits the radio data packet via a transmission port dynamically allocated by the system. The data packet carries the identifier (the information on the IP address, the number, etc.) of the mobile terminal B and the reception port number of the mobile terminal B. The radio data packet is transmitted directly to the mobile terminal B through the base station, and a routing network element at the network side, etc., instead of being transmitted to an instant communication server as in the prior art.

Correspondingly, a reception port via which a data packet of instant communication is received is also predefined in the mobile terminal B. After the mobile terminal B starts its own instant communication tool, the mobile terminal B monitors the reception port, and if the mobile terminal A transmits a data packet (that is, the transmitted data packet carries the identifier and the reception port number of the mobile terminal B) to the reception port of the mobile terminal B, the mobile terminal B may receive the data packet via the reception port.

S203. The mobile terminal B monitors the reception port and acquires the information from the received data packet upon determining reception of the data packet through the reception port.

After the mobile terminal B starts its own instant communication tool, the mobile terminal B monitors the predefined reception port and processes the data packet upon detecting reception of the data packet through the reception port. If the mobile terminal B adds the mobile terminal A as a friend and determines the received data packet as being transmitted from the mobile terminal A, the mobile terminal B receives, displays or stores the information of the data packet.

S204. The mobile terminal B returns a data packet to the mobile terminal A.

Similarly, the instant communication tool of the mobile terminal B may also generate a data packet from information input by the user of the mobile terminal B and transmit the generated data packet to the mobile terminal A. The data packet carries the identifier (including the IP address and/or the number) and the reception port number of the mobile terminal A. The data packet may be transmitted to the mobile terminal A by being routed and forwarded via the base station and a GSN at the network side.

S205. The mobile terminal A monitors the predefined reception port and acquires the information from the received data packet upon determining reception of the data packet via the reception port.

Similarly, the mobile terminal A also monitors the reception port and acquires the information from the received data packet upon determining reception of the data packet via the reception port. For example, the mobile terminal A acquires and displays or stores the information in the data packet upon determining the data packet as a data packet transmitted from the mobile terminal B.

Furthermore, the mobile terminal A may also determine whether there is a single data packet; and if so, the mobile terminal A receives and processes the data packet; otherwise, the mobile terminal A receives the data packets sequentially and processes them after all of them are received.

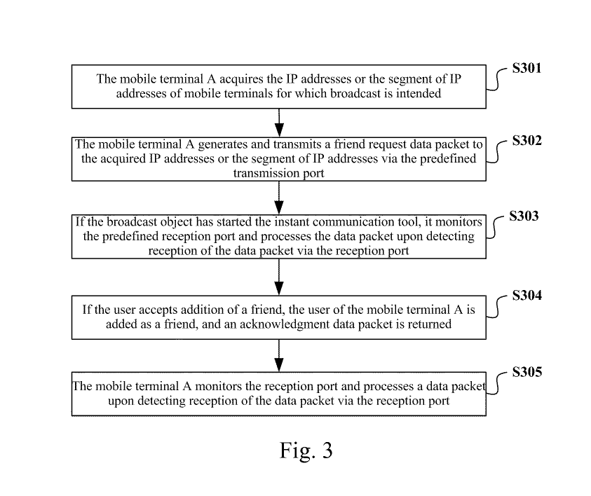

As an alternative to the foregoing method for instructing a mobile terminal at the opposite end to get online for instant communication and add an opposite peer as a friend with a short message, a mobile terminal with the instant communication tool enabled and capable of receiving/transmitting a data packet may add opposite peers as friends with IP addresses or a segment of IP addresses. FIG. 3 illustrates a flow chart of another method for adding a user of a mobile terminal at the opposite end, which includes the following specific steps.

S301. The mobile terminal A acquires the IP addresses or the segment of IP addresses of mobile terminals for which broadcast is intended.

After the user starts the instant communication tool provided according to the embodiment of the invention, the instant communication tool of the mobile terminal A acquires the IP addresses or the segment of IP addresses of mobile terminals for which broadcast is intended. The IP addresses or the segment of IP addresses may be input by the user into the mobile terminal A or selected from recorded IP addresses of other communication users.

S302. The mobile terminal A generates and transmits an instant communication request data packet to the acquired IP addresses or the segment of IP addresses of the mobile terminals for which broadcast is intended.

The instant communication request data packet generated by the mobile terminal A carries an identifier to indicate the information in the data packet as friend addition request information, reception port numbers of the recipients, the number of the local mobile terminal (i.e., the mobile terminal A) and the IP address of the local mobile terminal (i.e., the mobile terminal A). Furthermore, the instant communication request data packet may also carry information on the nickname of the user, a timeout period of time, etc.

S303. If the broadcast object has started the instant communication tool, it monitors the predefined reception port and processes the data packet upon detecting reception of the data packet via the reception port.

Upon detecting reception of the data packet via the reception port, if the broadcast object (e.g., the mobile terminal B) determines, from the identifier of getting-online instruction carried in the data packet, reception of a getting-online instruction, it acquires the information on the number, the IP address, etc., of the mobile terminal A carried in the instant communication request data packet and prompts the user about whether to add the mobile terminal A as a friend.

S304. If the user accepts addition of a friend, the user of the mobile terminal A is added as a friend, and an acknowledgment data packet is returned.

If the broadcast object (e.g., the mobile terminal B) accepts to add the user of the mobile terminal A as a friend, the mobile terminal B adds the user of the mobile terminal A as a friend in response to an acceptance instruction of the user, is ready to receive data from the IP address of the mobile terminal A and returns an acknowledgment data packet via a transmission port allocated by the system. The acknowledgement data packet carries information acknowledging addition of a friend and the identifier, the address and the reception port number of the mobile terminal A.

S305. The mobile terminal A monitors the reception port and processes a data packet upon detecting reception of the data packet via the reception port.

If the mobile terminal A detects reception of a data packet via the reception port and determines the data packet as an acknowledgment data packet transmitted from the broadcast object (e.g., the mobile terminal B), the mobile terminal A adds the user of the mobile terminal B as a friend. Thereafter the mobile terminals A and B may perform instant communication in the P2P mode.

Furthermore, the mobile terminal A may alternatively transmit the foregoing instant communication request data packet to one user according to the IP address of the user, that is, the broadcast object includes only one user, to thereby instruct the user about whether to add a friend.

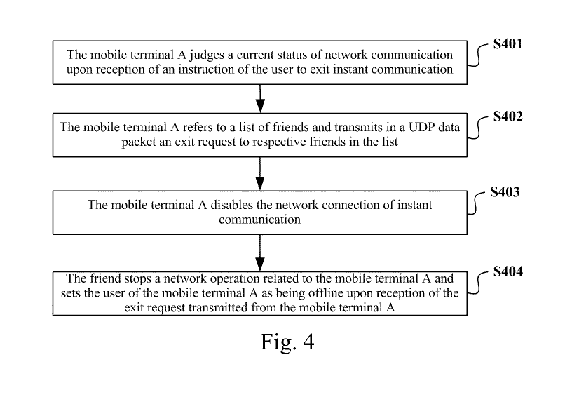

When the user of the mobile terminal A is going to get offline and thus exit instant communication, an exiting flow as illustrated in FIG. 4 includes the following specific steps.

S401. The mobile terminal A judges a current status of network communication upon reception of an instruction of the user to exit instant communication.

If the current status of network communication is a status of ongoing communication, an ongoing network operation is terminated after confirming again that the user is going to exit, particularly in the following steps.

S402. The mobile terminal A refers to a list of friends and transmits in a UDP data packet an exit request to respective friends in the list.

Specifically, the mobile terminal A transmits a data packet including an exit request to each of fiends according to the identifier and the reception port number of the mobile terminal of the friend. The data packet includes information on the identifier (e.g., the number and the address), etc., of the mobile terminal A, and a specific format and detailed contents thereof may be self-defined or comply with an existing standard, e.g., the RTSP protocol.

S403. The mobile terminal A disables the network connection of instant communication.

Specifically, the mobile terminal A disables the network connection of instant communication and stops reception and transmission of data and monitoring the reception port.

S404. The friend stops a network operation related to the mobile terminal A and sets the user of the mobile terminal A as being offline upon reception of the exit request transmitted from the mobile terminal A.

Assumed the user of the mobile terminal B is one of the friends, the mobile terminal B stops the network operation related to the mobile terminal A (for example, transmits or receives no more data packet to or from the mobile terminal A) and sets the user of the mobile terminal A as being offline upon detecting reception of the data packet, which includes the exit request, via the reception port.

Those skilled in the art can appreciate that although the steps of the method have been described sequentially in the foregoing description for the sake of facilitating understanding thereof, it shall be pointed out that the order of the foregoing steps may not be exactly restricted.

Actually, the transmission port and the reception port predefined in the mobile terminal A may be the same port or different ports; the predefined transmission port of the mobile terminal B may have the same port number as the predefined transmission port of the mobile terminal A; and the predefined reception port of the mobile terminal B may have the same port number as the predefined reception port of the mobile terminal A.

The data packet exchanged between the mobile terminals may be preferably in the UDP format to reduce an amount of traffic and lower a system load.

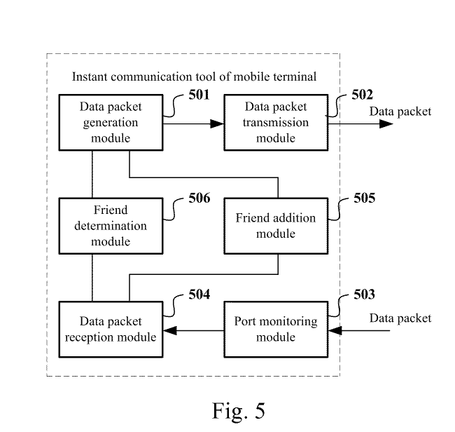

The instant communication tool of the mobile terminal provided according to the invention may perform the functions of the mobile terminal (including the mobile terminal A and the mobile terminal B), and as illustrated in FIG. 5, particularly include a data packet generation module 501, a data packet transmission module 502, a port monitoring module 503 and a data packet reception module 504.

The data packet generation module 501 is configured to generate, from information input by a user, a data packet carrying an identifier and a reception port number of a communication device at the opposite end.

The data packet transmission module 502 is configured to transmit the data packet to the communication device at the opposite end through a base station.

The port monitoring module 503 is configured to monitor a predefined reception port.

The data packet reception module 504 is configured to acquire, from a received data packet, information transmitted from the communication device at the opposite end upon determining the received data packet as being transmitted from the communication device at the opposite end when the port monitoring module detects reception of the data packet via the reception port. The instant communication tool may display or store the information acquired by the data packet reception module 504.

The reception port number of the communication device at the opposite end may be the same as the port number of the predefined reception port of the mobile terminal.

The instant communication tool in the mobile terminal may further include a friend addition module 505. The friend addition module 505 may include one of the following units:

a first friend addition unit configured to transmit a PUSH message in a short message mode to the communication device at the opposite end according to the number of the communication device at the opposite end, where the PUSH message includes a processing program identifier and a number and an IP address of the mobile terminal, and the processing program identifier is used to instruct a recipient to invoke an instant communication requesting program for prompting a user of the recipient about whether to perform instant communication with a user of the mobile terminal A, to return acknowledgement information in response to an instruction of the user of the recipient and to add the opposite peer as a friend according to the IP address of the mobile terminal (that is, get ready for instant communication with the mobile terminal); and to add the user of the communication device at the opposite end as a friend (that is, get ready for instant communication with the communication device at the opposite end) upon reception of acknowledgment information returned from the communication device at the opposite end; and

a second friend addition unit configured to broadcast an instant communication request data packet to several IP addresses through the mobile terminal, where the instant communication request data packet includes reception port numbers of recipients and the number of the mobile terminal, and the several IP addresses include the IP address of the communication device at the opposite end; and to add the user of the communication device at the opposite end as a friend (that is, get ready for instant communication with the communication device at the opposite end) in response to acknowledgment information returned from the communication device at the opposite end.

After the friend addition module 505 adds the user of the communication device at the opposite end as a friend, the data packet generation module 501 may generate the data packet transmitted to the communication device at the opposite end, and the data packet reception module 504 may receive the data packet transmitted from the communication device at the opposite end.

The instant communication tool in the mobile terminal may further include a friend determination module 506.

The friend determination module 506 may include one of the following units:

a first friend determination unit configured to invoke the instant communication requesting program upon determining the processing program identifier included in the received PUSH message as an identifier for instructing the recipient to invoke the instant communication requesting program, where the instant communication requesting program prompts the user about whether to perform instant communication with the user transmitting the PUSH message; and to return acknowledgement information in response to an instruction of the user and add the opposite peer as a friend (i.e., get ready for instant communication with the opposite peer); and

a second friend determination unit configured to prompt the user about whether to perform instant communication with the user of the mobile terminal A upon reception of the instant communication request data packet; and to return acknowledgement information in response to an instruction of the user and add the opposite peer as a friend.

After the friend determination module 506 adds the opposite peer as a friend, the data packet generation module 501 may generate the data packet transmitted to the opposite peer, and the data packet reception module 504 may receive the data packet transmitted from the opposite peer.

Furthermore, the instant communication tool of the mobile terminal may also include a friend management module configured to add and delete a friend, manage a list of friends and manage a corresponding relationship of friend information (numbers, addresses, user configuration information, etc.); and

an interface operation module configured to display related contents and messages and process a user instruction.

The mobile terminal according to the embodiment of the invention transmits a data packet directly to the device at the opposite end according to the identifier of the device at the opposite end through the base station and receives a data packet returned from the device at the opposite end by monitoring the predefined reception port instead of firstly transmitting information of instant communication to an instant communication server, which in turn forwards it to the device at the opposite end, thereby enabling transmission of instant communication data between the mobile terminals without being supported by any instant communication server.

Furthermore, since the mobile terminal transmits a PUSH message to the device at the opposite end to instruct the device at the opposite end to get online and add a friend, the opposite peer may be instructed in time to get online and add a friend even if the user of the device at the opposite end is offline to thereby achieve an enhanced nature of real time as compared with PC terminals in P2P instant communication over the Internet in the prior art.

Those ordinarily skilled in the art can appreciate that all or a part of the steps in the method according to the embodiments described above may be performed by a program instructing relevant hardware, which may be stored in a computer readable storage medium. e.g., an ROM/RAM, a magnetic disk, and an optical disk.

It can further be appreciated that the structure of the device illustrated in the drawings or the embodiments are merely illustrative of a logic structure, where modules illustrated as separate components may or may not be physically separate and a member illustrated as a module may or may not be a physical module.

The foregoing is merely illustrative of the preferred embodiments of the invention, and it shall be pointed out that those ordinarily skilled in the art can further make several modifications and variations without departing from the principle of the invention and these modifications and variations shall also be deemed as coming into the scope of the invention.

1. A data transmission method in a P2P mode for a mobile terminal, comprising:
generating, by the mobile terminal, a data packet from information input by a user, wherein the data packet carries an identifier and a reception port number of a communication device at the opposite end;
transmitting, by the mobile terminal, the data packet to the communication device at the opposite end through a base station; and
monitoring a predefined reception port, and acquiring, from a received data packet, information transmitted from the communication device at the opposite end upon detecting reception of the data packet via the reception port and determining the received data packet as being transmitted from the communication device at the opposite end.

2. The method of claim 1, wherein the reception port number of the communication device at the opposite end is the same as a port number of the predefined reception port of the mobile terminal.

3. The method of claim 2, further comprising: after the mobile terminal transmits the data packet to the communication device at the opposite end through the base station,
acquiring, by the communication device at the opposite end, the information in the data packet upon determining the received data packet as being transmitted from the mobile terminal after detecting reception of the data packet through a port corresponding to the reception port number; and
returning, by the communication device at the opposite end, to the mobile terminal a data packet carrying an identifier and the reception port. number of the mobile terminal.

4. The method of claim 3, further comprising: before the mobile terminal generates the data packet from the information input by the user,
transmitting, by the mobile terminal, a PUSH message in a short message mode to the communication device at the opposite end according to a number of the communication device at the opposite end, wherein the PUSH message comprises a processing program identifier and a number of the mobile terminal;
invoking, by the communication device at the opposite end, instant communication requesting program according to the processing program identifier upon reception of the PUSH message, wherein the instant communication requesting program prompts a user about whether to perform instant communication with a user of the mobile terminal, and returning acknowledgment information in response to an instruction of the user; and
getting ready, by the mobile terminal, to perform instant communication with the communication device at the opposite end in response to the acknowledgement information returned from the communication device at the opposite end.

5. The method of claim 4, wherein returning by the communication device at the opposite end the acknowledgment information comprises:
returning, by the communication device at the opposite end, a data packet comprising the acknowledgment information, wherein the data packet carries the identifier and the reception port number of the mobile terminal; or
returning, by the communication device at the opposite end, in a short message mode a PUSH message comprising the acknowledgment information.

6. The method of claim 3, further comprising: before the mobile terminal generates the data packet from the information input by the user,
broadcasting, by the mobile terminal, an instant communication request data packet to several IP addresses through the base station, wherein the instant communication request data packet comprises reception port numbers of recipients and a number of the mobile terminal, and the several IP addresses comprise an IP address of the communication device at the opposite end;
prompting, by the communication device at the opposite end, a user about whether perform instant communication with a user of the communication terminal upon reception of the instant communication request data packet, and returning acknowledgement information in response to an instruction of the user; and
getting ready, by the mobile terminal, to perform instant communication with the communication device at the opposite end in response to the acknowledgement information returned from the communication device at the opposite end.

7. The method of claim 1, wherein the identifier comprises an IMSI and/or an IP address.

8. A mobile terminal, comprising:
a data packet generation module configured to generate, from information input by a user, a data packet carrying an identifier and a reception port number of a communication device at the opposite end;
a data packet transmission module configured to transmit the data packet to the communication device at the opposite end through a base station;
a port monitoring module configured to monitor a predefined reception port; and
a data packet reception module configured to acquire, from a received data packet, information transmitted from the communication device at the opposite end upon determining the received data packet as being transmitted from the communication device at the opposite end when the port monitoring module detects reception of the data packet via the reception port.

9. The mobile terminal of claim 8, wherein the reception port number of the communication device at the opposite end is the same as a port number of the predefined reception port of the mobile terminal.

10. The mobile terminal of claim 8, further comprising a friend addition module, wherein the friend addition module comprises one of:
a first friend addition unit configured to transmit a PUSH message in a short message mode to the communication device at the opposite end according to a number of the communication device at the opposite end, wherein the PUSH message comprises a processing program identifier and a number and an IP address of the mobile terminal, and the processing program identifier is used to instruct a recipient to invoke an instant communication requesting program for prompting a user of the recipient about whether to perform instant communication with a user of the mobile terminal, to return acknowledgement information in response to an instruction of the user of the recipient and to add the opposite peer as a friend according to the network address information; and to get ready for instant communication with the communication device at the opposite end upon reception of acknowledgment information returned from the communication device at the opposite end; and
a second friend addition unit configured to broadcast an instant communication request data packet to several IP addresses through the mobile terminal, wherein the instant communication request data packet comprises reception port numbers of recipients and the number of the mobile terminal, and the several IP addresses comprise the IP address of the communication device at the opposite end; and to get ready for instant communication with the communication device at the opposite end in response to acknowledgment information returned from the communication device at the opposite end.

11. The mobile terminal of claim 10, further comprising a friend determination module, wherein the friend determination module comprises one of:
a first friend determination unit configured to invoke the instant communication requesting program upon determining the processing program identifier comprised in the received PUSH message as an identifier for instructing the recipient to invoke the instant communication requesting program, wherein the instant communication requesting program prompts the user about whether to perform instant communication with the user transmitting the PUSH. message; and to return acknowledgement information in response to an instruction of the user and get ready for instant communication with the opposite peer; and
a second friend determination unit configured to prompt the user about whether to perform instant communication with the user of the mobile terminal upon reception of the instant communication request data packet; and to return acknowledgement information in response to an instruction of the user and get ready for instant communication with the opposite peer.
